(19) United States
(12) Patent Application Publication
(10) Pub. No.: US 2013/0073221 A1
(43) Pub. Date: Mar. 21, 2013

(54) SYSTEMS AND METHODS FOR IDENTIFICATION OF FLUID AND SUBSTRATE COMPOSITION OR PHYSICO-CHEMICAL PROPERTIES

(71) Applicants: Daniel Attinger, Ames, IA (US); Frederic Zenhausern, Fountain Hills, AZ (US); Cedric Hurth, Tempe, AZ (US); Shih-Fu Chang, New York, NY (US); Zhenguo Li, New York, NY (US)

(72) Inventors: Daniel Attinger, Ames, IA (US); Frederic Zenhausern, Fountain Hills, AZ (US); Cedric Hurth, Tempe, AZ (US); Shih-Fu Chang, New York, NY (US); Zhenguo Li, New York, NY (US)

(21) Appl. No.: 13/619,338

(22) Filed: Sep. 14, 2012

Related U.S. Application Data
(60) Provisional application No. 61/535,801, filed on Sep. 16, 2011.

(51) Int. Cl. G06F 19/00

(52) U.S. Cl. CPC G06F 19/70
USPC 702/30

(57) ABSTRACT

Techniques for identifying a composition of a target fluid using a set of vectors representing known residue patterns for a two or more fluids including said target fluid is provided. An exemplary method includes storing one or more digital measurements of residue for the target fluid, extracting one or more descriptive features from the measurements; and processing descriptive features to identify the composition of the target fluid. The processing includes using a machine learning algorithm trained with data linking residue morphology to fluid composition. A distance between a vector representing said one or more descriptive features and said set of vectors representing known residue patterns is determined, and a residue is assigned to one or more of the known residue patterns.

### CROSS-REFERENCE TO RELATED APPLICATIONS

This application claims the benefit of U.S. Provisional Application No. 61/535,801, filed Sep. 16, 2011, the disclosure of which is incorporated by reference herein in its entirety.

### STATEMENT REGARDING FEDERALLY SPONSORED RESEARCH

This invention was made with government support under grant no. 1034349 awarded by the National Science Foundation. The government has certain rights in the invention.

### BACKGROUND

Pattern recognition can apply to various fields by substituting routine work requiring human senses such as sight, hearing, taste, touch and smell. Developed pattern recognition and machine vision techniques can be deployed in manufacturing assembly lines for automatic defect detection, in public safety and forensics for recognizing individuals on the basis of fingerprints, face, voice and handwriting. Other applications can include food analysis, health or disease monitoring and environmental monitoring for identifying physical and chemical data, including using sensor arrays, such as electronic noses and tongue, as well as spectroscopic techniques, such as mass spectrometry, chromatography and electrophoresis.

When a drop of a complex fluid is deposited on a solid substrate, it typically dries and leaves a stain, which can be a complex signature of the deposition and drying conditions, of the morphology and physico-chemical properties of the substrate, its interactions with the fluid and/or of the composition of the fluid. The formation of patterns during the drying of small liquid droplets can be of interest to biotechnology and materials science. Further, certain stains can assume particular shapes, such as a peripheral ring, a central bump or a uniform deposit. The structure of the stain can be determined by the relative role of three convective transport phenomena involved in the deposition of the nanoparticles on the solid surface, i.e. the normal flow caused by electrostatic and Van der Waals forces, the radial flow caused by the maximum evaporation rate at the contact line, and the Marangoni recirculation caused by surface tension gradient at the air-liquid interface. The staining process can be parallelized and can occur within a few seconds because of Marangoni convection and receding of the initial wetting line for sub-microlitre drops.

Certain patterns can appear in a reproducible manner in stains of fluids and substrates of controlled chemistry, and can show multiple length scales, specific periodicity and features like lines, rings, crystals, and various grain sizes. Manual inspection of these features can provide certain information about the liquid and substrate. However, manual identification can be tedious and expensive, particularly when many measurements are to be identified. Further, the results of manual identification can be unreliable because of large and unpredictable variations of human factors. Accordingly, there is a need for an automated pattern recognition approach that is fast, data-driven, and not subject to human bias.

### SUMMARY

Systems and methods for identification of fluid and substrate physico-chemical properties are provided herein.

The disclosed subject matter provides methods for identifying a composition or a physico-chemical property of a target fluid using a set of vectors representing known residue patterns for a two or more fluids including the target fluid. In certain embodiments, a method can include storing one or more digital measurements of residue for said target fluid on a substrate, extracting one or more descriptive features from at least one of the measurements, and processing descriptive features to identify the composition or physico-chemical property of the target fluid from the measurements.

The processing can include using a machine learning algorithm trained with data linking residue morphology to fluid composition or physico-chemical properties. A distance between a vector representing the descriptive features and set of vectors representing known residue patterns can be determined, and a residue can be assigned to one or more of the known residue patterns, e.g., a residue that minimizes said distance.

In some embodiments, the method can include placing a quantity of a fluid substance on a substrate, where the substrate dries and leaves a residue, and acquiring one or more digital measurements of the residue.

In some embodiments, extracting one or more descriptive features can include performing automatic localization of the residue as a region of interest in the measurement. In some embodiments, the measurement can include an image, and automatic localization of the residue can include converting an input image into a binary-formatted image, determining a largest object in the binary-formatted image to be the residue, determining a boundary area of the largest object, and/or cropping an area in the input image corresponding to the boundary area of the largest object.

In some embodiments, extracting the one or more descriptive features can include assembling one or more row vectors from discriminative feature vectors having relative weights, the discriminative feature vectors characterizing one or more of a color distribution, a local binary pattern, a Gabor wavelet pattern, and a residue size. The discriminative feature vectors can characterize a color distribution, and the method can further include computing the color distribution. Computing the color distribution can include converting an input image into a color space having multiple color channels, computing a pixel histogram for each of the color channels, computing a mean, standard deviation, skew, energy and/or entropy for each color channel corresponding to multiple components for each color channel, and normalizing each of the components to a unit vector corresponding to the color distribution.

Additionally or alternatively, the discriminative feature vectors can characterize a local binary pattern, and the method can further include computing the binary pattern. Computing the binary pattern can include labeling each pixel in an input image by thresholding each pixel with a gray level value of a center pixel, and assigning each pixel a binary number corresponding to the thresholding with the gray level value.

The disclosed subject matter also provides method for identifying fluid composition data. In certain embodiments, a method can include storing one or more digital measurements of liquid residue on a substrate, extracting one or more descriptive features from at least one of said measurements, and processing descriptive features to classify the selected measurement. The processing can include using an unsupervised and trained machine learning technique, identifying patterns common to several measurements in a residue dataset, if any, and grouping similar residues into clusters without labeled data, such that each cluster, and each of the similar residues grouped therein, corresponds to a distinct visual pattern.

In some embodiments, the method can include placing a quantity of a fluid on a substrate, where the fluid dries and leaves a residue, and acquiring one or more digital measurements of the residue.

In some embodiments, extracting one or more descriptive features can include performing automatic localization of the residue as a region of interest in the measurement. In some embodiments, the measurement can include an image, and automatic localization of the residue can include converting an input image into a binary-formatted image, determining a largest object in the binary-formatted image to be the residue, determining a boundary area of the largest object, and cropping an area in the input image corresponding to the boundary area of the largest object.

Additionally or alternatively, extracting the one or more descriptive features can include assembling one or more row vectors from discriminative feature vectors having relative weights. The discriminative feature vectors can characterize one or more of a color distribution, a local binary pattern, a Gabor wavelet pattern, and a residue size.

In some embodiments, the discriminative feature vectors can characterize a color distribution, and the method can further include computing the color distribution.

In some embodiments, the discriminative feature vectors can characterize a local binary pattern, and the method can further include computing the binary pattern. Computing the binary pattern can include labeling each pixel in an input image by thresholding each pixel with a gray level value of a center pixel, and assigning each pixel with a binary number corresponding to the thresholding with the gray level value.

In some embodiments, processing one or more of said descriptive features to classify said measurement can include clustering said measurement and one or more other of the stored digital measurements.

The disclosed subject matter also provides method for identifying fluid composition or physico-chemical data. In certain embodiments, a method can include storing one or more digital measurements of fluid residue on a substrate, extracting one or more descriptive features from at least one of the measurements, and processing descriptive features to classify the selected image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram of an exemplary system for identification of composition or physico-chemical properties of a fluid.

FIG. 2 shows exemplary consumable fluid stains according to the disclosed subject matter.

FIG. 3 shows exemplary biological fluid stains according to the disclosed subject matter.

FIGS. 4A-4G illustrate an exemplary method for pattern recognition of stains according to the disclosed subject matter.

FIGS. 5A-5E illustrate further features of the method of FIGS. 4A-4G.

FIGS. 6A-6E illustrate further features of the method of FIGS. 4A-4G.

FIGS. 7A-7B illustrate further features of the method of FIGS. 4A-4G.

FIG. 8 illustrates further features of the method of FIGS. 4A-4G.

### DETAILED DESCRIPTION

Systems and methods for identification of fluid and substrate properties based on automatic pattern recognition of stains are provided herein. As referenced herein, for example and without limitation, a “stain” can include any material deposit or pattern remaining after fluid dries on a substrate.

The disclosed subject matter provides techniques for identification of fluid and substrate composition or physico-chemistry using algorithms trained with existing data linking stain morphology to liquid and substrate composition or physico-chemistry to identify the liquid and substrate composition or physico-chemistry of an unknown stain, including qualitatively and/or quantitatively.

The disclosed subject matter also provides using automated pattern recognition methods to group stains in a way that discriminates between specific combinations of liquid and substrate chemistry, morphology or other physico-chemical properties, for example and without limitation, rheological properties.

The pattern recognition algorithms described herein can include performing automatic localization (or cropping) of a stain as a region of interest in an image and extracting and computing descriptive features from the image. The descriptive features can be expressed quantitatively as a row vector f=[αf_{C}, βf_{L}, γf_{G}, εf_{S}]. The vector can be assembled from four discriminative feature vectors, with relative weights that can be expressed by α, β, γ, and ε. The feature vectors can characterize the color distribution as f_{C}, the local binary patterns (LBP) as f_{L}, the Gabor wavelet pattern as f_{G}, and the relative stain size as f_{S}, as further described below.

Machine learning techniques can then be applied, for example and without limitation, a classification technique and/or a clustering technique. Classification can be performed by supervised pattern recognition algorithms, which can include comparing stain patterns in question with a set of training patterns of which the liquid/substrate category is known, computing the distance between the vector f of an unknown stain with vectors representing labeled stains, and assigning the unknown stain to the class of labeled stains that minimize that distance. Clustering can utilize unsupervised pattern recognition algorithms to identify patterns common to several measurements in a stain dataset and group similar stains into a manually determined number of clusters (or classes) without labeled data, such that each cluster corresponds to a distinct visual pattern.

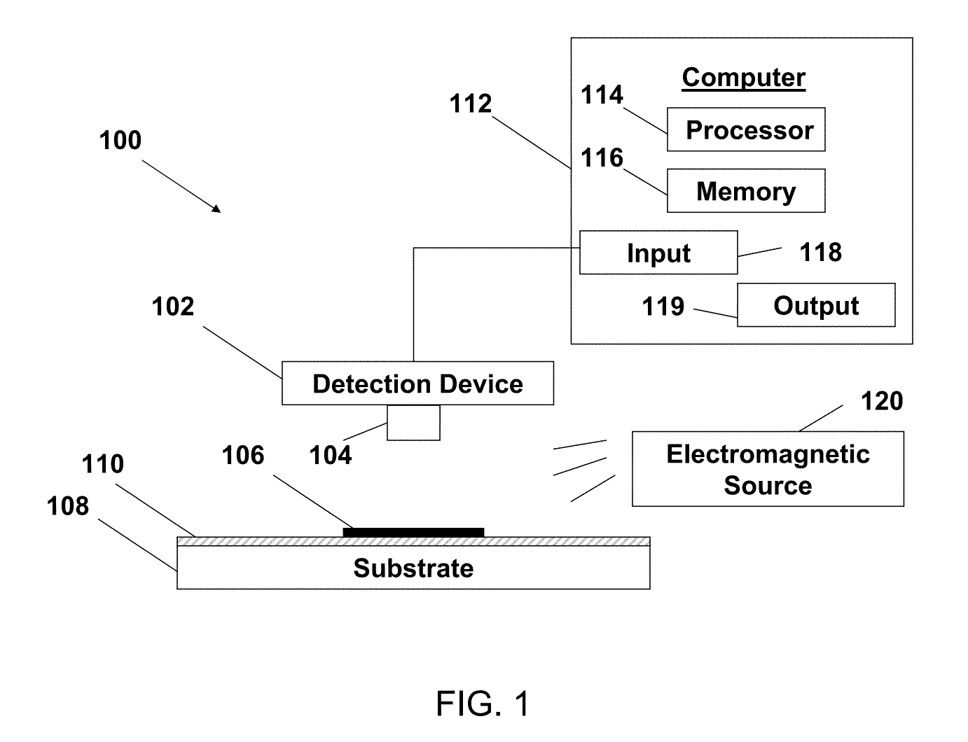

FIG. 1 shows a diagram of an exemplary system 100 for identifying a composition of a fluid. The system includes a detection device 102, which can be, for example and without limitation, an imaging or spectroscopic device. The detection device 102, as described further herein, can include one or more components, such as lenses or filters 104, which can be configured to transmit and/or receive a signal, such as an electromagnetic or optical signal, and enhance certain features of an image received and/or transmitted by the detection device 102, such as the image size and/or clarity. The imaging device 102 can be configured to acquire measurements of a residue 106. Residue 106 can be formed on a substrate having a surface 108, which can be for example and without limitation a glass slide, and which can include one or more coatings 110, for example and without limitation a streptavidin coating. Coating 110 can be provided to interact with one or more targeted materials or component of said fluid, such as biotin or other biomarker(s) interacting through a hybridization process, chemical or physical interaction, and/or to enhance the clarity of residue 106, as described further herein. System 100 can also include an electromagnetic source 120, for example and without limitation a light source, configured to illuminate the residue 106.

As described herein in connection with certain embodiments, a computer 112 can communicate with detection device 102 and is provided to acquire data and generate classification and/or clustering data therefrom, which can be used to identify the composition and/or physico-chemical properties of a target fluid. The computer 112 can include one or more processors 114, one or more memories 116, one or more inputs 118 and one or more outputs 119. In these embodiments, the computer 112 plays a significant role in permitting the system to identify a composition of a target fluid. For example and as described further herein, the presence of the computer 112 provides image manipulation, image feature extraction and multi-dimensional vector analysis. Furthermore, computer 112 can also perform, for example and without limitation, statistical analysis, bioinformatics functions, rheological analysis and/or measurements of other properties of interest, which can be used for medical diagnostics, food analysis, biodefense, forensics or other biological and/or chemical applications.

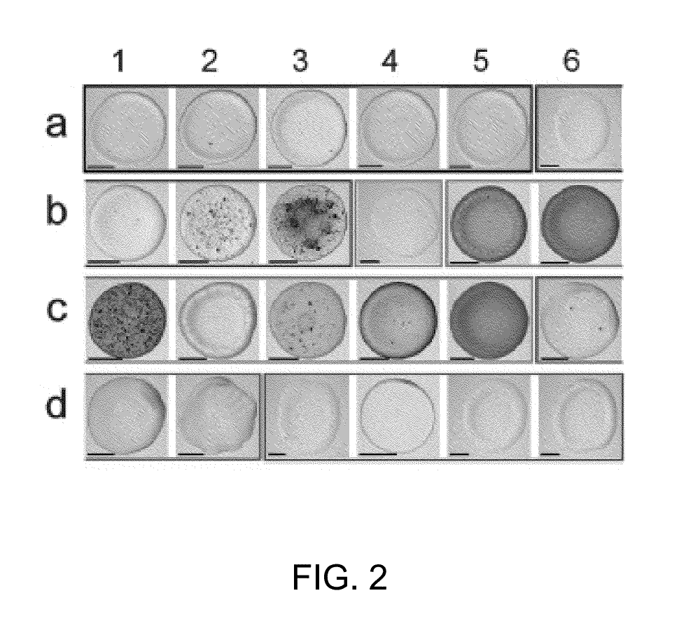

FIG. 2 shows exemplary measurements of residues 106 from consumable fluids acquired using an exemplary imaging device 102. For example and embodied herein, the exemplary imaging device 102 can include an inverted microscope (IX 71, Olympus, Center Valley, Pa.) with a 2× objective lens (UIS2 PLN, NA=0.06, WD=5.8 mm, Olympus) and a color complementary metal oxide semiconductor (CMOS) camera (PL-A776, PixeLINK, Ottawa, ON, Canada) under bright field transillumination from a halogen lamp (U-LH100L-3, Olympus) through frost (LP453900, Olympus) and day light filters (9-U115). The acquired image from the exemplary imaging device with 2,040×1,536 pixel resolution at 20 ms exposure time resulted in a picture scale of 1.61 μm/pixel.

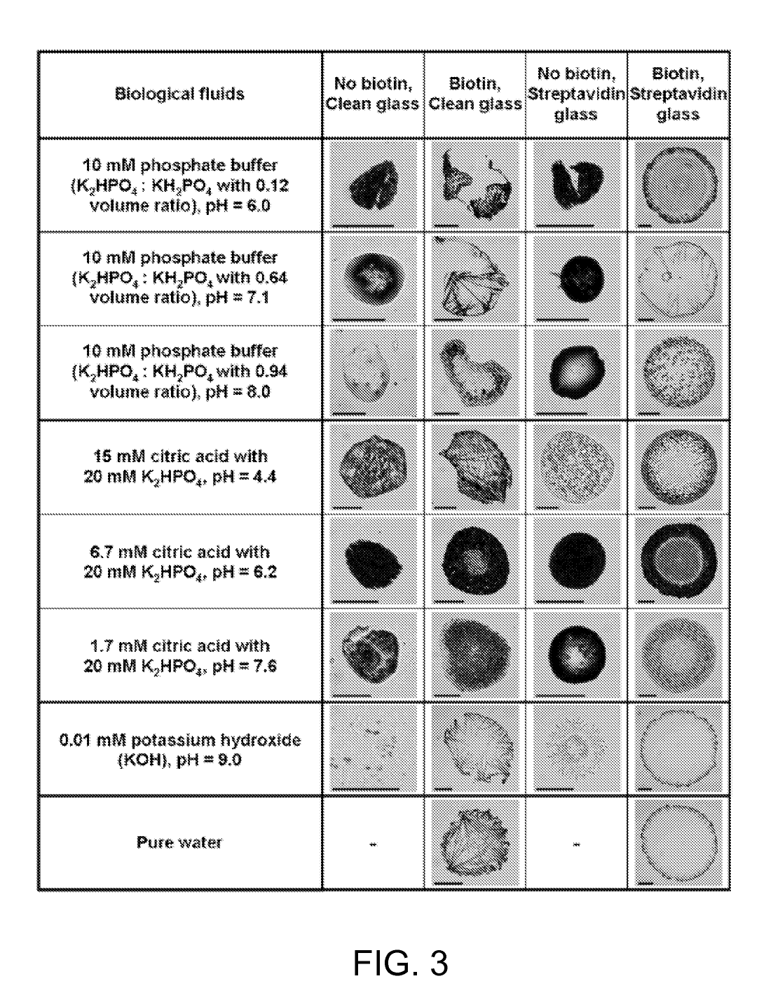

FIG. 3 shows measurements of example stains from biological fluids. The fluid composition is shown in the first column, and the first row shows whether the fluid contains biotin and whether the glass slide has been cleaned, for example and without limitation with Piranha solution, and/or coated with streptavidin. The measurements from biological fluid of FIG. 3 were acquired using an alternative embodiment of an imaging device 102. For example and embodied herein, the exemplary imaging device 102 can include a Nikon Eclipse Ti-U inverted microscope equipped with a Nikon 2× objective lens (Plan Achromat UW, Nikon, NA=0.06, WD=7.5 mm) and a color CMOS camera (PL-E425CU, PixeLINK, Ottawa, ON, Canada). The acquired image resolution of the exemplary imaging device was set to 2,040×1,536 pixels with a 20 ms exposure time. Calibration with an etched glass ruler can produce a calculated resolution of 1.03 μm/pixel. The intensity of the incident light (100 W Halogen) can be adjusted to deliver 90 μW at 560 nm, as measured by a 9 mm diameter silicon photodiode sensor (S130C, Thorlabs, Newton, N.J.).

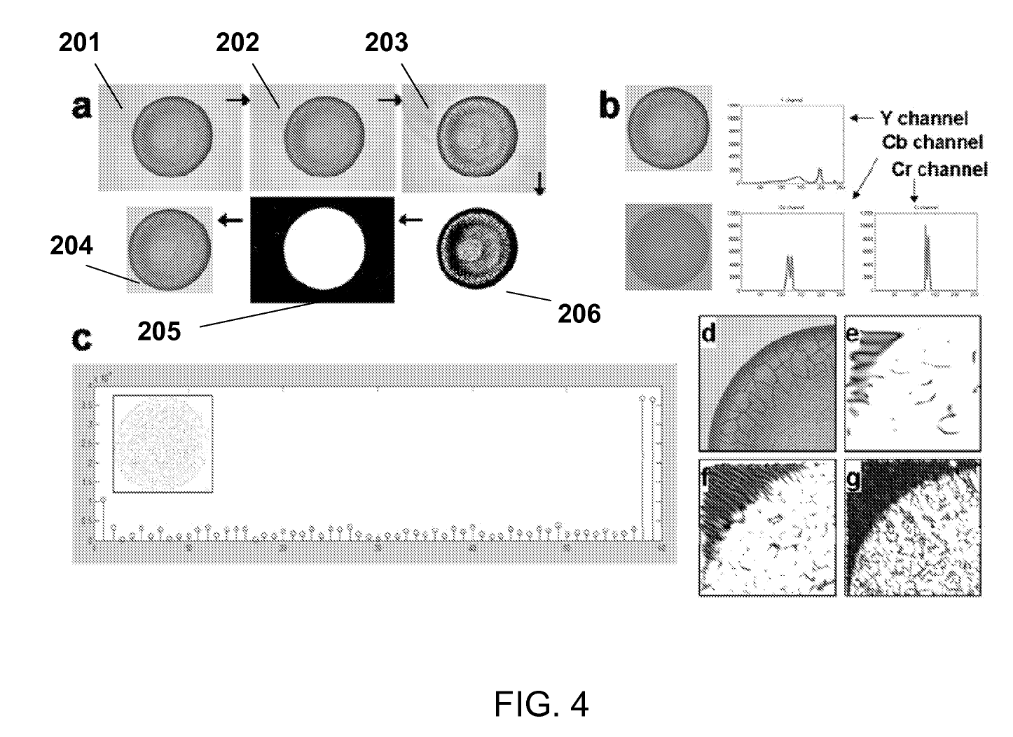

FIGS. 4A-4G illustrate an exemplary method for pattern recognition of stains. FIG. 4A shows the automatic localization of the stain. The region containing the stain can be cropped from the raw input image into a rectangle slightly larger than the stain to reduce the adverse effect of irrelevant background as follows. A raw input image can be received in RGB format (201). The raw input image can then be converted into grayscale format (202), can have a contrast enhanced (203), and then can be converted into a binary formats (204). The binary image can be converted, holes in the inverted image can be filled up to have complete objects (205), and an object having the largest area can be treated as a stain. A bounding box can be fitted to this area, and the area of the stain can be cropped from the original image with an offset on all sides in order to improve selection of the entire stain (206). The cropped image can then be resized to a 256×256 pixel image. As described above, complete sets of the cropped stain measurements from consumable and biological fluids are shown in FIG. 2 and FIG. 3, respectively.

In an exemplary embodiment, a stain can be described by a combined feature vector f=[αf_{C}, βf_{L}, γf_{G}, εf_{S}], where f_{C}, f_{L}, f_{G}, and f_{S} can be row vectors representing respectively the color features, local binary patterns, Gabor features and size of the stain.

Color features can be described by the vector f_{C}. Color features can be used as low-level features for content-based image analysis, and can be suitable against noise, resolution, orientation and resizing. The color feature of an image can be captured by its pixel distribution (histogram), in a color space. For example and without limitation, a 3-component YCbCr color space can be utilized instead of the original RGB space. For each color channel, i.e., Y, Cb, or Cr, a pixel histogram can be computed, as shown for example in FIG. 4B, and then the mean, standard deviation, skew, energy, and entropy can be calculated. In this manner, each of the three color components can be represented by five features, and thus f_{C} can be a 15×1 vector. The range of each dimension can be normalized linearly to [0, 1] to balance the importance among each feature.

Local binary patterns (LBPs) can be represented by the vector f_{L}. LBP can label the pixels of an image by thresholding its neighborhood with the gray level value of the center pixel. Each pixel can be associated with a sequence of binary number, and the histogram of the decimal numbers that correspond to the binary sequence of these binary numbers can be taken as the LBP features for the image. For example, a neighborhood of 8 pixels can be used, as in the consumable fluid dataset, and each center pixel can be assigned with a sequence of 8 binary numbers, and as such the histogram can be of length 2⁸=256. An exemplary LBP with 3×3 neighborhoods (8 pixels) and uniform pattern is shown in FIG. 4C. Alternatively, a neighborhood of 16 pixels, as in the biological fluid dataset, can have a histogram length of 2¹⁶=65,536.

To reduce the length of the feature vector and implement a rotation-invariant descriptor, patterns that typically reflect noise, from, for example, a uniform background signal, can be removed from the histogram. The size of the vector f_{L}, used in the calculations can be 10×1 for the consumable fluid dataset and 243×1 for the biological fluid dataset.

Gabor features can be represented by the Gabor vector f_{G}. Gabor filters can be considered as a set of filters, also called Gabor wavelets, designed to describe the local texture properties of an image in various directions and scales. In an exemplary embodiment, Gabor filters can be configured in 4 scales and 6 directions, giving 24 filters in total. Each filter can return two values or responses. Each cropped image can be divided along the vertical and horizontal symmetry axis into 4 sub-measurements, and a Gabor transform can be performed on each sub-image. Accordingly, with 24 filters, there can be 48 response results for each sub-image, which can correspond to a Gabor vector f_{G} of size 192×1 for each image. FIGS. 4D-4G show Gabor transform results on a sub-image. FIG. 4D shows one of 4 sub-measurements from a grayscale image. FIG. 4E shows a Gabor transformed image of the image of FIG. 4D with scale 2 and degree 0. FIG. 4F shows a Gabor transformed image of the image of FIG. 4D with scale 3 and degree 30. FIG. 4G shows a Gabor transformed image of the image of FIG. 4D with scale 4 and degree 60. Further, the size feature vector f_{S}, which can have a size of 1×1, can be set as the total number of pixels in the cropped image.

For classification purposes, for purpose of illustration and not limitation, the k-nearest neighbor algorithm can be used, as described further below. For clustering, for purpose of illustration and not limitation, three exemplary algorithms can be used, the k-means, average linkage and spectral clustering algorithms, as described further below.

The k-nearest neighbor algorithm (k-NN) can be considered as a supervised learning algorithm for classifying objects based on closest training examples in the feature space. A training dataset X={(xᵢyᵢ)}ᵢ₌₁ⁿ of n labeled measurements can be first built where each image can be represented by its feature vector xᵢεR^{d}, and by its known integer class label yᵢε{1, . . . , c}, with c representing the chosen number of classes. A test object zᵢεR^{d} can then be classified to the majority class of its k nearest neighbors in the training set to the minimum ∥z−xᵢ∥. If k=1, an object can be assigned to the class of its nearest neighbor in the training dataset.

To balance the importance of each feature used in classification, each feature dimension can be linearly normalized in the training data into the interval [0, 1], and then the same transformation can be applied to the associated feature dimension in the test data. In one example, fᵢ can be the i^{th} feature dimension of the n training data, f_{i,min}=min(fᵢ), and f_{i,max}=max(fᵢ). A linear transformation can be applied as follows:

Tᵢ:fᵢ→[0,1]x→aᵢx+bᵢ (1)

so that Tᵢ(f_{i,min})=0 and Tᵢ(f_{i,max})=1. This can be achieved with:

$${a}_{i} = \frac{1}{{f}_{i , ma x} - {f}_{i , m i n}} and {b}_{i} = - {a}_{i} {f}_{i , m i n} . \qquad ( 2 )$$

For an exemplary test image x=(xᵢ, . . . , x_{d}), the transformation T(x)=(T₁(x₁), . . . , T_{d}(x_{d})) can be applied before making the classification. For clustering, each feature dimension of the data can be linearly normalized to interval [0, 1].

For an unlabeled dataset z₁, . . . , zₙεR^{d}, the k-means algorithm can find k centers c₁, . . . , cₖεR^{d} to reduce the following quantization loss:

$${\sum }_{i = 1}^{n} {min}_{j} {‖ {z}_{i} - {c}_{j} ‖}^{2} . \qquad ( 3 )$$

The integer number k can be a manually set number that corresponds to the number of clusters into which the measurements are to be sorted. An object can then be grouped to its nearest center, using the nearest neighbor algorithm. In practice, one can alternate between the data partition and center update. k centers can be randomly selected. Each object can then be grouped to its nearest center. The current center in a cluster can be replaced by way of the objects in that cluster. The latter two operations can be repeated until convergence.

The average linkage algorithm can be considered as a linkage clustering algorithm, and can yield a cluster hierarchy over the data, in a bottom-up manner. Each object can be treated as an individual cluster first. Two closest clusters can then be merged. This operation can be repeated until some desired conditions are met. In an exemplary embodiment, the operation can be stopped when k clusters of the data are obtained. In average linkage, the distance between two clusters can be taken as the average distance between objects across clusters, i.e.:

$$d ( {C}_{i ,} {C}_{j} ) = \frac{1}{{n}_{i} {n}_{j}} {\sum }_{x ∈ {C}_{i ,} y ∈ {C}_{j}} ‖ x - y ‖ \qquad ( 4 )$$

where nᵢ and nⱼ can represent the numbers of objects in clusters Cᵢ and Cⱼ, respectively.

The spectral clustering algorithm can be considered as a graph-based method. From a dataset, a graph can be built with each object as a node, and the similarity between two objects can serve as the weight on the edge joining the associated nodes. W=(wᵢⱼ) can be the similarity matrix of the graph, and wᵢⱼ can capture the similarity between nodes i and j, and can be represented as:

wᵢⱼ=exp(−∥xᵢ−xⱼ∥^{2/σ}), (5)

where σ can represent a scale factor. The degree of node i can be defined as:

dᵢ=Σⱼwᵢⱼ, (6)

and D=diag(d₁, . . . , dₙ) can represent the degree matrix. The Laplacian matrix of the graph can be defined as L=D−W. Normalized Cuts (Ncuts), a type of spectral clustering, can be used for clustering. The Ncuts clustering can find a balanced partitioning of the graph, and can lead to the following generalized eigenvalue equation:

Lv=λDv (7)

where the eigenvector v₂, which can correspond to the second smallest eigenvalue, can be the relaxed indicator vector for two-way partition. For an exemplary K-way partition, the relaxed cluster indicator matrix can be obtained as F=(v₂, . . . , v_{K}), where vᵢ can represent the unit eigenvector corresponding to the i^{th} smallest eigenvalue. To derive K clusters, k-means can be applied to the rows of F, and object i can be grouped to the cluster of row i.

To measure the quality of the clustering process, the Normalized Mutual Information (NMI) technique can be applied as follows. For a clustering of the data, denoted as P₁=(C₁, . . . , C_{K}), a discrete random variable X can represent the cluster-membership of a randomly selected object. Thus X can take on K values, and

$$P ( X = {C}_{i} ) = \frac{{n}_{i}}{n} \qquad ( 8 )$$

where nᵢ can represent the number of objects in cluster Cᵢ. Y can be the random variable associated with another partition of the same data P₂=(A₁, . . . , A_{M}). The joint distribution of X and Y can be represented as:

$$P ( X = {C}_{i ,} Y = {A}_{j} ) = \frac{{n}_{ij}}{n} \qquad ( 9 )$$

where nᵢⱼ can represent the number of objects in Cᵢ ∩ Aⱼ. The NMI between the partition P₁ and P₂ can be represented as:

$$NMI ( {P}_{1 ,} {P}_{2} ) = \frac{I ( X , Y )}{\sqrt{H ( X ) H ( Y )}} \qquad ( 10 )$$

where I(X,Y) can be the mutual information between X and Y, and H(X) and H(Y) can be the entropies of X and Y, respectively, and NMI can be within the closed interval [0, 1]. An NMI closer to 1 can represent a relatively close alignment between the clustering results and another set of partitions, such as ground truth categories, of the same dataset.

### Example

In one example, two comprehensive collections of microscopic stain measurements were constructed from 100 nL drops of consumable and biological fluids to test pattern recognition algorithms. The first dataset includes 480 stain measurements from 24 consumable fluids (24 classes) such as beer, juice, liquor, milk, red wine, and soda, all deposited on clean glass slides. For each fluid, 20 stains were produced. The second dataset includes 600 stain measurements from 8 biological fluids (8 classes) such as 10 mM phosphate buffer made from three different ratii of K₂HPO₄ and KH₂PO₄, 20 mM phosphate buffer with pH values obtained from three different concentrations of citric acid, a solution of 0.01 mM potassium hydroxide and water. All fluids were deposited on two different types of glass slides, clean or coated with streptavidin, which resulted in 16 classes, as described further below. The number of classes was doubled again (32 classes) by adding biotin to each solution. However, water on both clean and streptavidin glasses (2 classes) did not generate suitable stains, thus 30 classes were established for the biological fluids. For both datasets, the drying conditions and the substrate morphology were kept constant.

Consumable fluids including beers (Budweiser® Lager, Corona® Extra, Guinness® Extra Stout, Heineken® Lager, and Tsingtao® Lager), juices (Tropicana® Grape, Tropicana® Lemonade, Tropicana® Orange No Pulp, and Campbell's® Tomato), liquor (Disaronno® Originale Amaretto), milks (Horizon® 1% Low Fat, Horizon® 2% Reduced Fat, Horizon® Chocolate, Horizon® Fat Free, Silk® Soy, Horizon® Strawberry, and Horizon® Whole), red wines (2007 Chateau de Castelneau from Bordeaux, France, Merlot, 2008 Liberty School from Paso Robles, Calif., USA, Syrah, and 2008 Graham Beck from Franschhoek, South Africa, Cabernet Sauvignon), and sodas (Coca Cola® Classic, Diet Coke®, Dr Pepper®, and Fanta® Orange) were purchased from local stores. The fluids were used within 2 hours after opening of the original containers.

For the biological fluids, a series of aqueous buffer solutions were prepared using biotechnology performance certified-grade water (Sigma-Aldrich W3513, Saint-Louis, Mo.). A first subset includes phosphate buffer (PB) solutions prepared to a final concentration of 10 mM using three different volume ratii of K₂HPO₄ and KH₂PO₄ (Sigma-Aldrich, Saint-Louis, Mo.) calculated according to the Henderson-Hasselbach formula to yield respective pH values of 6.03, 7.05, and 7.98 as checked by a pH meter (Acorn ph 6, Oakton Instruments, Vernon Hills, Ill.) calibrated with NIST standard solutions of pH=4.00 and 7.00. A second subset of solutions includes Mcllvaine buffers, i.e. a mixture of 20 mM K₂HPO₄ and 15, 6.7 or 1.7 mM citric acid. This yields final pH values of 4.42, 6.19, and 7.64 respectively, as checked using a freshly calibrated pH meter. A third subset of solutions includes a 10⁻⁵ M KOH solution, and the control, biotechnology performance certified-grade water, to attest of the absence of parasite particles in all solutions prepared. A similar series of biotin-containing solutions was prepared by dissolving biotin powder (Pierce Biotechnology, Inc. 29129, Rockford, Ill.) to a final concentration of 1.32 mM. All solutions were filtered using a syringe filter with Nylon membranes with 0.2 μm pores (Pall Acrodisc-25, Port Washington, N.Y.) to remove all dust particles and undissolved buffer or biotin crystals.

Microscope glass slides (12-544-1, Fisher Scientific, Pittsburgh, Pa.) were cleaned by immersion in a 3:1 volume mixture of sulfuric acid (H₂SO₄) and 30% hydrogen peroxide (H₂O₂) for 2 minutes, then rinsed extensively with filtered deionized water, and blown dry with compressed nitrogen gas in a class 1,000 cleanroom. To reduce wettability for deposition of the red wine drops, glass slides rinsed with filtered deionized water and dried with a stream of nitrogen gas were used. Streptavidin-coated glass slides (SMS, Arrayit Corporation, Sunnyvale, Calif.) were also rinsed with filtered deionized water, and subsequently dried with a stream of filtered nitrogen. Then, 0.1 μL droplets were deposited on the glass slide using calibrated micropipettes (0.1-2.5 μL, Eppendorf, Hauppauge, N.Y. and P2, Gilson, Inc., Middleton, Wis.) by making slight contact between the surface and the liquid protruding from the pipette tip and subsequently pulling the micropipette away from the surface. The pipetting accuracy was determined by measuring the area occupied by 20 spots of a solution made of 1.32 mM biotin in water relative to the entire image field of view. The solution can have a suitable spreads while still leaving a residue dense enough to be distinguished from the rest of the surface. The dried residue area was approximated by a box stretched to fit the residue and the area was measured by software (ImageJ, NIH, Bethesda, Md.) and normalized to the entire image area. The area averaged at 7.5% of the entire field of view with a standard deviation of 0.8%. The average and standard deviation can reflect manual pipetting errors and/or local differences in the glass surface. The slides were arrayed at room temperature of 20-23° C. with a relative humidity (RH) of 20-50% and immediately placed in a desiccator filled with anhydrous calcium chloride (CaCl₂) or calcium sulfate (CaSO₄) powders where they were allowed to dry for 24 h before imaging.

FIG. 2 shows stains obtained from consumable fluid drops. All stains had approximately the same size, roughly equal to the initial wetted area. The stains were highly reproducible for a given consumable fluid and distinct among fluid types. Beer stains showed no significant differences in terms of shape and color except for the Guinness® Extra Stout, which showed a browner annulus in the vicinity of the wetting line as the stout itself was darker than the other beers. Some waves or fingering were visible along the wetting line in the Tropicana® grape juice stain, while other stains from juice showed no fingering at the wetting line. Circular black spots and fibrous deposits were observed in the stains from orange and tomato juices, respectively. The stains from seven types of milks showed different levels of brown color, which seemed proportional to the nominal concentration of fat. On the other hand, crack patterns were observed on the peripheral annulus for the samples with the lowest fat concentration. Milk stains with additional ingredients like chocolate, strawberry, as well as soy milk, showed randomly distributed spots. Wine stains from Merlot and Cabernet Sauvignon showed radial wrinkles, while stains from Syrah did not. The four kinds of soda stains showed similar ring deposits, with a thick ring for the sugary sodas and a thin ring for the sugar-free diet Coke.

The k-nearest neighbor (k-NN) algorithm with k=1 can be applied for the classification of the dataset of stains from consumable fluids. The Euclidean distance metric can be used to measure the distances between feature vectors. The set of the consumable fluids, shown in FIG. 2, includes 24 classes, with 20 measurements in each class. For purpose of illustration, 10 measurements from each class can be used as training data, and the remaining 10 measurements can be used as test data. The classification accuracy can be tested based on each extracted feature vector like color distribution, LBP, Gabor wavelet and size feature and their combination, according to the image processing shown in FIGS. 4A-4D and described above. The 1-NN algorithm based on the extracted features can improve the classification accuracy compared to random assignments, which was only 4.2%. The color distribution feature provided for classification with an accuracy reaching 94%, while other features, LBP, Gabor wavelet and size features provided accuracies of 89%, 75%, and 17%, respectively.

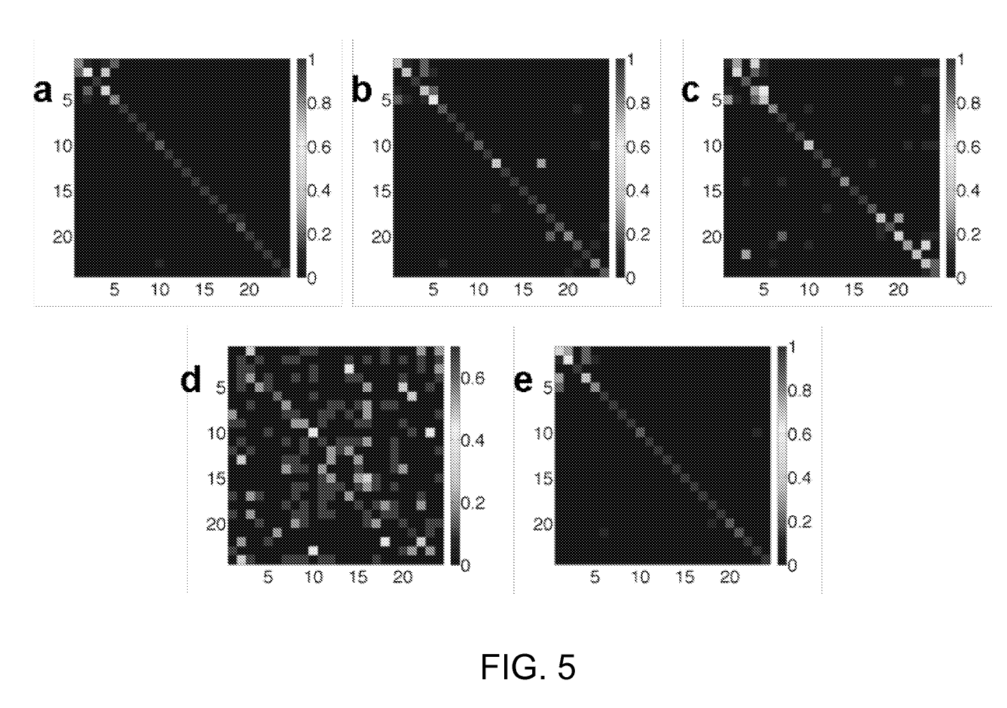

FIGS. 5A-5E show classification accuracy of consumable fluids based on the 1-nearest neighbor algorithm using color distribution (FIG. 5A, accuracy of 0.94), local binary patterns (FIG. 5B, accuracy of 0.89), Gabor wavelet (FIG. 5C, accuracy of 0.75), size (FIG. 5D, accuracy of 0.17) and combination of 4 features (FIG. 5E, accuracy of 0.93). The axis of the matrices correspond to the position of the stain measurements in FIG. 2, numbered from left to right and then top to bottom.

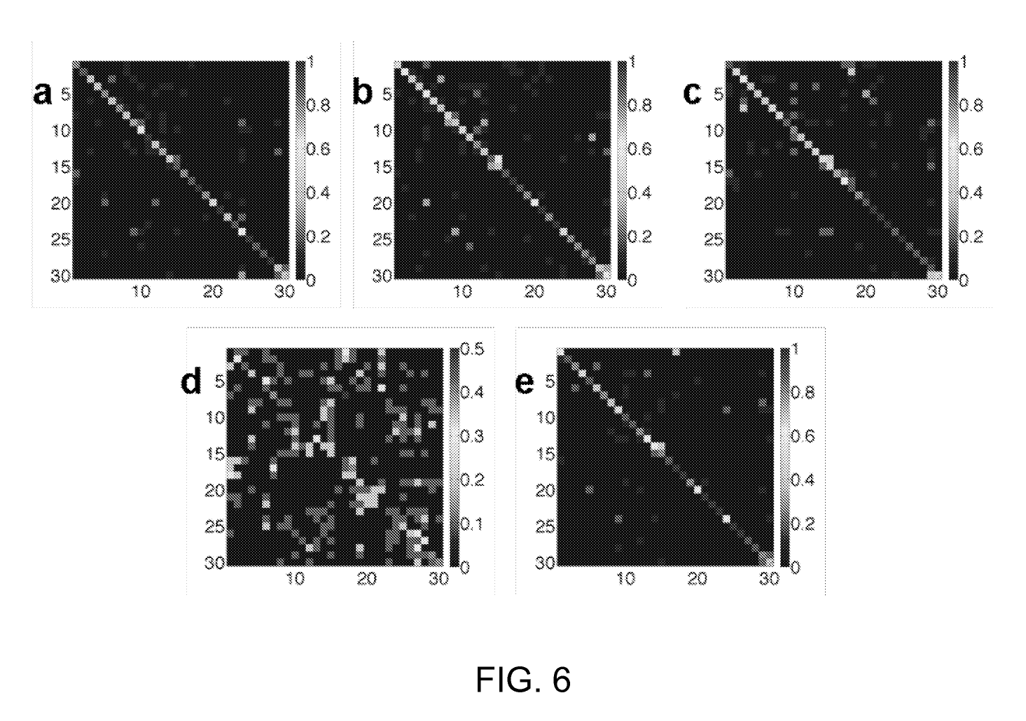

FIGS. 6A-6E show classification accuracy of biological fluids based on the 1-nearest neighbor algorithm using color distribution (FIG. 6A, accuracy of 0.76), local binary patterns (FIG. 6B, accuracy of 0.64), Gabor wavelet (FIG. 6C, accuracy of 0.64), size (FIG. 6D, accuracy of 0.14) and combination of 4 features (FIG. 6E, accuracy of 0.81). The axis of the matrices correspond to the position of the stain measurements in FIG. 3, numbered from top to bottom, then left to right.

In FIGS. 5A-5E and 6A-6E, each figure represents a confusion matrix, in which each column of the confusion matrix, summed to 1, records the classification portion of the corresponding class. For example, an entry (i, j) in the confusion matrix can represent the proportion of measurements in class j being classified into class i. In FIG. 5A, the first five indices corresponding to the upper left area represent stains from beers. As such, most of the inaccuracy of the classification based on the color distribution feature aroused from beer stains. This is due at least in part to the similar appearance of the beer stains. The classification accuracy of the beer stains based on the color distribution feature was 72%, and excluding beer stains from the dataset increased the classification accuracy of consumable fluids stains to 99%.

Classification based on a combined feature vector f=[αf_{C}, βf_{L}, γf_{G}, εf_{S}], with optimal value of the weighting factors α=1−β−γ−ε, was determined using the leave-one-out cross-validation (LOOCV) method described in the Methods section. Each of the weighting factors ranged between 0 and 1. For the consumable fluid data, weighting factors determined by the LOOCV method were α=0.8, β=0.1 and γ=0.1, and ε=0 and corresponded to a classification accuracy of 93%, which is slightly lower than the accuracy based on the color distribution feature alone (94%). This is due at least in part because, when a single feature is dominant in classification performance, a combination of that feature with less dominant features does not necessarily improve accuracy, and can even degrade accuracy. An exemplary confusion matrix for the classification accuracy of consumable fluids based on the 1-nearest neighbor algorithm using LBP, Gabor wavelet, size, and combination of features is shown in FIGS. 5B-5E.

Several clustering algorithms can be applied to the dataset including k-means, average linkage, and spectral clustering, as described above. Clustering can group data into clusters, where objects within a cluster are similar to each other while those across clusters are dissimilar, according to certain criteria. To measure the quality of the clustering performance, the Normalized Mutual Information (NMI) can be applied, as described above, by measuring the normalized mutual information between the clustering result and the ground-truth clusters. The maximum clustering accuracy of 87% for the consumable fluid dataset in NMI was achieved when the color distribution feature was used.

Another collection of stain measurements was prepared using biological fluids (as shown in FIG. 3) such as phosphate buffer (K₂HPO₄/KH₂PO₄) at different volume ratios, phosphate solutions (K₂HPO₄) added of different volumes of citric acid to control pH, and KOH solutions. To show the effects of specific molecular interactions between the solution and the solid substrate, two versions of each fluid were prepared (one including biotin, and the other not), and two versions of the glass slides were prepared (one coated with streptavidin and the other not). The biotin-streptavidin system can exhibit a strong non-covalent interaction between a protein and its cofactor binding constant of the system, which can be represented as K_{D}=4×10⁻¹⁴ M or, equivalently, a force of 160 pN as measured by atomic force microscopy. This system can also be utilized in biotechnology, for example in high affinity sensitive immunoenzymatic assays (e.g. ELISA) or nucleic acids-based assay chemistries (e.g. DNA hybridization).

The prepared biological fluids deposited on the clean glass and streptavidin-coated glass slides formed unique stains, as shown in FIG. 3, except the pure water droplet deposited on a clean glass slide (which is not shown because it did not leave a visible stain). The variation in diameter of the biological stains was on the order of one order of magnitude, which is larger than for the consumable stains. When drops of 10 mM phosphate buffer with different volume ratio were deposited on the clean and streptavidin-coated glass slides, a small-diameter bump was formed, due at least in part to Marangoni convection and receding of the initial wetting line. Visual inspection showed the following about the effect of pH: the more acid solution (i.e., the 15 mM citric acid solution) left crystallized patterns in the bump on the clean glass slide and scattered granular patterns on the streptavidin coated glass slide, while more basic solutions (i.e., 6.7 mM and 1.7 mM of citric acid) formed more homogeneous bumps on both glass slides.

The KOH solution deposited on the streptavidin-coated glass slide showed circular snowflake stains, where random spots formed on the clean glass slide. Adding 1.32 mM biotin to each solution changed the stain pattern, as shown by comparing the first column with the second column in FIG. 3 for the clean glass surface and the third column with the fourth column for the streptavidin-coated glass. The presence of biotin in the phosphate buffer with 15 mM citric acid produced needle patterns in the stains when deposited on the clean glass slide, where it formed globular patterns when biotin was not in solution. Addition of biotin to KOH and water deposited on the clean glass slide produced thin needles pointing inward from the periphery.

Stains from all the solutions added with biotin maintained circular shapes after the drying process, due at least in part to its strong non-covalent interaction between biotin in solution and streptavidin coated on the glass slide. However, different patterns were observed at the interior of the stains depending on the solution used. Altering the volume ratio of the phosphate buffers resulted in stains with short needles at the wetting line and multiple concentric lines inside the wetting line, coarse long needles pointing inward at the periphery without inside concentric lines and scattered granular pattern, as the volume ratio increased. The 10 mM citric acid in phosphate solution with biotin showed thorny crown patterns when deposited on the streptavidin coated glass slide. Stains from 6.7 mM and 1.5 mM citric acid in phosphate solution with biotin on the streptavidin glass slide formed more apparent annular ring patterns compare to when deposited on the clean glass slide. Water and KOH drops added with biotin showed substantially identical stains when deposited on the streptavidin coated glass slide, i.e. shorter needles around the periphery than when deposited on the clean glass slide.

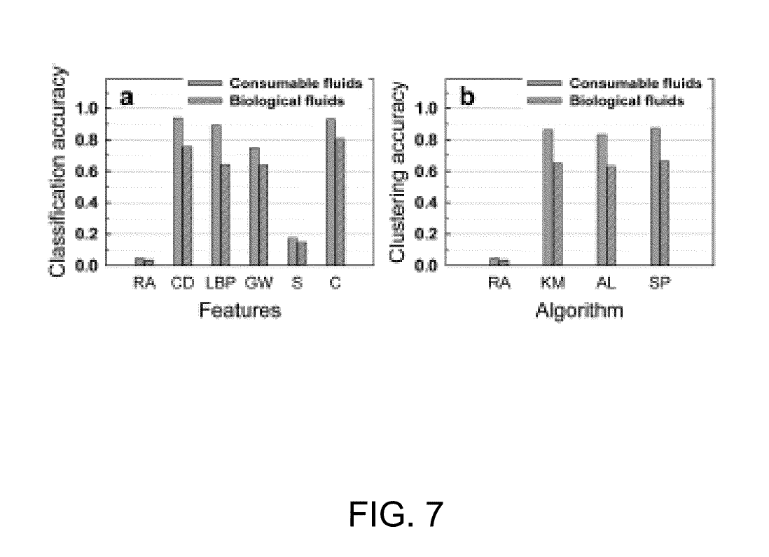

The dataset of biological fluids includes 30 classes with different fluid composition and substrate chemistry. 20 measurements were taken per class, with 10 measurements per class used as training data and the remaining measurements used to test the pattern recognition algorithms. The accuracy of the classification process is shown in FIG. 7A. An accuracy of 81% was obtained by the combination of the four features (color, LBP, Gabor and size), which improves upon the accuracy of 3.3% obtained by random assignment. As with the dataset of consumable fluids, the color distribution was the most discriminative single feature, followed by the LBP, Gabor and size feature. Contrary to the dataset of consumable fluids, the combination of four features provided higher accuracy than the single feature of color distribution, due at least in part because the features observed in the biological fluids were richer than the ones observed in the consumable fluids. The classification accuracy with the biological fluids was not as high as the accuracy with the consumable fluids.

FIG. 7B shows a comparison of the clustering accuracy using three different clustering algorithms. As shown, the spectral clustering algorithm delivered the most accurate result, with 66% accuracy for 30 classes.

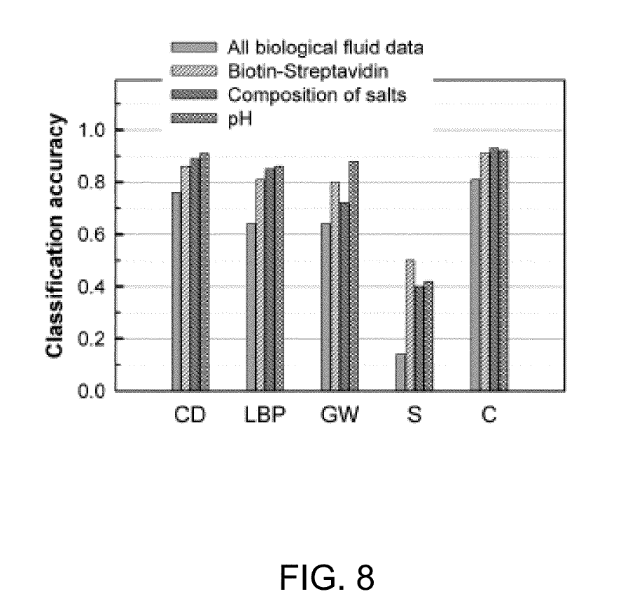

FIG. 8 shows the performance of classification algorithms to determine the presence or absence of biotin and streptavidin respectively in the liquid and on the glass (4 classes), the salt composition (3 classes), or the pH of the solution (3 classes). For each of the three tasks, pattern recognition algorithms using combined features returned a classification accuracy greater than 90%, even though the influence on the stain image of pH, biotin/streptavidin, and citric acid can be difficult to determine by visual inspection.

Accordingly, and as described above, biological and consumable fluids can be classified and clustered by pattern recognition techniques based on descriptive features (for example and without limitation, color distribution, local binary pattern, Gabor wavelet, and size) extracted from photographic measurements of the stains. For biological and consumable fluid datasets, the color distribution can be the most discriminative single feature. The nearest neighbor classification, which can be based on the combined features, can achieve the highest classification and clustering accuracy for biological fluids. However, for consumable fluids, the color distribution feature alone can achieve the highest accuracy. Results with the dataset of stains from consumable fluids can have a slightly higher accuracy than that from biological fluids. This can be due at least in part to the large variations of composition of the biological fluids considered. The algorithms can also determine the presence or absence of biotin and streptavidin respectively in the liquid and on the glass, the salt composition, or the pH of the solution.

The pattern recognition scheme according to the disclosed subject matter can thus perform pattern recognition in recognizing specific fluids from the raw stain measurements of the fluids. Applications of the disclosed subject matter include clinical diagnostics, for example and without limitation for the classification of pleural effusions for malignancy, congestive heart failure or lung infection, and can allow rapid screening at the point-of-care. A person having ordinary skill in the art will recognize that protein systems other than avidin or biotin can be utilized, for example and without limitation to quickly determine protein content of clinical samples, such as pleural effusions or cerebrospinal fluid for early diagnosis, and investigate specific interactions between the fluid and biomarkers patterned on the surface. Throughput can also be increased by utilizing a micro-arrayer to form the droplets.

What is claimed is:

1. A method for identifying at least one of a physico-chemical property or composition of a target fluid using a set of vectors representing known residue patterns for a two or more fluids including said target fluid, comprising:
acquiring one or more digital measurements of residue for said target fluid;
extracting one or more descriptive features from at least one of said measurements; and
processing one or more of said descriptive features to identify said at least one physico-chemical property or composition of said target fluid from said at least one of said measurements;
wherein said processing includes using a matching algorithm or a machine learning algorithm trained with data linking residue patterns to fluid composition or physico-chemical properties.

2. The method of claim 1, further comprising:
determining a distance between a vector representing said one or more descriptive features and said set of vectors representing known residue patterns, and
assigning a residue to one or more of the known residue patterns that minimizes said distance.

3. The method of claim 1, wherein acquiring one or more digital measurements comprises capturing one or more images.

4. The method of claim 1, wherein said acquiring further comprises:
placing a quantity of a fluid on a substrate, wherein the fluid dries and leaves said residue.

5. The method of claim 1, wherein extracting one or more descriptive features comprises performing automatic localization of the residue as a region of interest in the measurement.

6. The method of claim 5, wherein the one or more measurements comprises one or more images, and automatic localization of the residue comprises:
converting an input image into a binary-formatted image;
determining a largest object in the binary-formatted image to be the residue;
determining a boundary area of the largest object; and
cropping an area in the input image corresponding to the boundary area of the largest object.

7. The method of claim 1, wherein extracting the one or more descriptive features comprises assembling one or more row vectors from discriminative feature vectors having relative weights, the discriminative feature vectors characterizing one or more of a color distribution, a local binary pattern, a Gabor wavelet pattern, and a residue size.

8. The method of claim 7, wherein the discriminative feature vectors characterize a color distribution, the method further comprising computing the color distribution, including:
converting an input image into a color space having a plurality of color channels;
computing a pixel histogram for each of the plurality of color channels;
computing a mean, standard deviation, skew, energy and entropy for each color channel corresponding to a plurality of components for each color channel; and
normalizing each of the plurality of components to a unit vector corresponding to the color distribution.

9. The method of claim 7, wherein the discriminative feature vectors characterize a local binary pattern, the method further comprising computing the binary pattern, including:
labeling each pixel in an input image by thresholding each pixel with a gray level value of a center pixel; and
assigning each pixel with a binary number corresponding to the thresholding of the gray level value.

10. A method for identifying fluid composition data, comprising:
acquiring one or more digital measurements of liquid residue;
extracting one or more descriptive features from at least one of said measurements; and
processing one or more of said descriptive features to classify said at least one measurement;
wherein said processing includes using an unsupervised and trained machine learning technique, and
identifying patterns common to several measurements in a residue dataset, if any, and grouping similar residues into clusters without labeled data, such that each cluster, and each of the similar residues grouped therein, corresponds to a distinct visual pattern.

11. The method of claim 10, wherein said acquiring further comprises:
placing a quantity of a fluid substance on a substrate, wherein the substrate dries and leaves said residue.

12. The method of claim 10, wherein the at least one measurement comprises at least one image, and extracting one or more descriptive features comprises performing automatic localization of the residue as a region of interest in the image.

13. The method of claim 12, wherein automatic localization of the residue comprises:
converting an input image into a binary-formatted image;
determining a largest object in the binary-formatted image to be the residue;
determining a boundary area of the largest object; and
cropping an area in the input image corresponding to the boundary area of the largest object.

14. The method of claim 10, wherein extracting the one or more descriptive features comprises assembling one or more row vectors from discriminative feature vectors having relative weights, the discriminative feature vectors characterizing one or more of a color distribution, a local binary pattern, a Gabor wavelet pattern, and a residue size.

15. The method of claim 14, wherein the one or more measurements comprises at least one image and the discriminative feature vectors characterize a color distribution, the method further comprising computing the color distribution, including:
converting an input image into a color space having a plurality of color channels;
computing a pixel histogram for each of the plurality of color channels;
computing a mean, standard deviation, skew, energy and entropy for each color channel corresponding to five components for each color channel; and
normalizing each of the five components to a unit vector corresponding to the color distribution.

16. The method of claim 14, wherein the discriminative feature vectors characterize a local binary pattern, the method further comprising computing the binary pattern, including:
labeling each pixel in an input image by thresholding each pixel with a gray level value of a center pixel; and
associating each pixel with a sequence of binary numbers corresponding to the gray level value.

17. The method of claim 10, wherein processing one or more of said descriptive features to classify said at least one measurement comprises clustering said at least one measurement and one or more other of the stored digital measurements.

18. A system for identifying at least one of a composition or a property of a target fluid using a set of vectors representing known residue patterns for a two or more fluids including said target fluid, comprising:
one or more memories storing multimedia data;
one or more processors coupled to said one or more memories;
a detection device configured to capture a measurement of residue for said target fluid on a substrate, coupled to said one or more processors and said one or more memories so as to store said measurement in said one or more memories; and
a computer readable medium containing digital information coupled to said one or more processors, said digital information comprising a machine learning algorithm trained with data linking residue morphology to fluid composition or physico-chemical properties, where when executed said digital information causes said one or more processors to:
extract descriptive features from said measurement obtained from said detection device,
determine a distance between a vector representing said one or more descriptive features and said set of vectors representing known residue patterns, and
assign the fluid residue to one or more of the known residue patterns that minimizes said distance.

19. The system of claim 18, wherein the detection device comprises an inverted microscope.

20. The system of claim 19, wherein the microscope comprises one or more objective lenses.

21. The system of claim 18, wherein the detection device comprises a CMOS camera.

22. The system of claim 18, wherein the substrate comprises a solid material

23. The system of claim 18, wherein the substrate comprises a glass slide.

24. The substrate of claim 22, wherein said material is transparent to an electromagnetic wave.

25. The substrate of claim 22, wherein said material is non-transparent to an electromagnetic wave

26. The system of claim 18, wherein the substrate comprises a biomolecular coating.

27. The system of claim 18, wherein the substrate comprises a Streptavidin protein coating.

28. The system of claim 18, further comprising an electromagnetic source configured to illuminate the residue.
